(19) United States
(12) Patent Application Publication
(10) Pub. No.: US 2026/0058159 A1
(43) Pub. Date: Feb. 26, 2026

(54) NEGATIVE ELECTRODE INTERFACE MODIFICATION MATERIAL AND CELL USING THE SAME

(71) Applicant: FORMOSA SMART ENERGY TECH CORPORATION, Taipei City (TW)

(72) Inventors: Yan-Ming Lai, Taitung City (TW); Jheng-Yi Huang, Dapi Township (TW); Ru-Shi Liu, New Taipei City (TW); Hui-Chi Liu, Taipei City (TW); Ruey-Yu Wang, Taipei City (TW)

(21) Appl. No.: 18/812,100

(22) Filed: Aug. 22, 2024

(51) Int. Cl. H01M 4/62; H01M 4/02; H01M 10/0525; H01M 10/0562

(52) U.S. Cl. CPC H01M 4/628; H01M 10/0525; H01M 10/0562; H01M 2004/027; H01M 2300/0071

(57) ABSTRACT

A negative electrode interface modification material for a cell is provided. The negative electrode interface modification material comprises succinonitrile, a polymer, a lithium salt, and an additive. A lithium-ion solid-state cell comprising the negative electrode interface modification material is also provided.

### BACKGROUND

The present invention provides a negative electrode interface modification material for cells, especially a negative electrode interface modification material comprising succinonitrile, a polymer, a lithium salt, and an additive. The present invention also provides a lithium-ion solid-state cell comprising the negative electrode interface modification material.

### DESCRIPTIONS OF THE RELATED ART

In response to global warming and climate change, implementing energy conservation and carbon reduction is currently a primary goal. Enhancing energy storage efficiency is a key issue in energy conservation. Lithium-ion cells are one of the most widely used energy storage systems. However, conventional lithium-ion cells use liquid-state electrolytes, which pose safety issues due to their flammability. Consequently, recent research on lithium-ion cells has focused on flame-retardant inorganic solid-state electrolytes, with lithium aluminum germanium phosphate-based electrolytes being particularly promising.

A specific example of lithium aluminum germanium phosphate-based electrolyte is Li_{1.5}Al_{0.5}Ge_{1.5} (PO₄)₃ (LAGP) electrolyte. The LAGP electrolyte possesses the advantages of air stability and an ionic conductivity of about 10⁻⁴ S/cm. However, there is an issue of potential mismatch between the LAGP electrolyte and lithium metal (commonly used as an electrode material in lithium-ion cells), resulting in an unstable relationship between LAGP and lithium (Li). The germanium ions (Ge⁴⁺) in LAGP can be reduced to lower valence state ions Ge²⁺ or Ge by lithium, which hinders the migration of lithium ions. This issue restricts the application of LAGP electrolyte in lithium-ion cells. It is known that forming an amorphous germanium (Ge) film on the surface of LAGP can suppress the reduction reaction of germanium ions (Ge⁴⁺) with lithium (Li), and create a close contact between lithium metal and LAGP electrolyte, thereby reducing interfacial impedance. However, the ionic conductivity of the LAGP electrolyte with the amorphous germanium (Ge) film is low, and the voltage of the positive electrode material is also restricted.

In addition, plastic crystal electrolytes (PCE) based on succinonitrile can achieve an ionic conductivity of about 10⁻³ S/cm at room temperature and have a wide electrochemical window. However, using succinonitrile-based electrolytes leads to poor mechanical performance of the cell, and lithium metal can catalyze side reactions of nitrile polymerization, resulting in poor cycle stability of the cell.

### SUMMARY

In view of the above technical issues, the present invention provides a negative electrode interface modification material that can address the contact problems and side reaction issues between lithium aluminum germanium phosphate-based electrolytes and lithium metal. This modification material aims to provide lithium-ion cells with high chemical stability, low impedance, high electrochemical stability, and excellent cycle stability. Furthermore, the resultant lithium-ion cells produced can possess good mechanical properties while maintaining high ionic conductivity.

Therefore, an objective of the present invention is to provide a negative electrode interface modification material, which comprises succinonitrile, a polymer, a lithium salt, and an additive.

In one embodiment of the present invention, the polymer is selected from the group consisting of poly(ethylene oxide) (PEO), polyacrylonitrile (PAN), poly(vinylidene difluoride) (PVDF), poly(propylene carbonate) (PPC), poly(methyl methacrylate) (PMMA), and combinations thereof.

In one embodiment of the present invention, the polymer has a weight average molecular weight ranging from 20,000 to 4,000,000.

In one embodiment of the present invention, the lithium salt is selected from the group consisting of lithium bis(trifluoromethanesulfonyl)imide (LiTFSI), LiPF₆, LiBF₄, LiClO₄, LiAsF₆, LiCF₃SO₃, and combinations thereof.

In one embodiment of the present invention, the additive is selected from the group consisting of fluoroethylene carbonate (FEC), ethylene carbonate (EC), vinylene carbonate (VC), and combinations thereof. In the preferred embodiments of the present invention, the additive is FEC.

In one embodiment of the present invention, based on the total weight of succinonitrile, the polymer, the lithium salt, and the additive, the amount of the polymer ranges from greater than 0 wt % to 20 wt %, and the amount of the additive ranges from greater than 0 wt % to 15 wt %.

In one embodiment of the present invention, based on the total weight of succinonitrile, the polymer, the lithium salt, and the additive, the amount of the lithium salt ranges from 5 wt % to 15 wt %, and the amount of succinonitrile ranges from 60 wt % to 90 wt %.

Another objective of the present invention is to provide a lithium-ion solid-state cell, which comprises a positive electrode, a negative electrode, a solid-state electrolyte, and the aforementioned negative electrode interface modification material, wherein the negative electrode interface modification material is disposed between the negative electrode and the solid-state electrolyte.

In one embodiment of the present invention, the negative electrode is made of a material selected from the group consisting of lithium metal, a lithium-indium alloy, a lithium-aluminum alloy, a silicon-lithium alloy, and combinations thereof.

In one embodiment of the present invention, the solid-state electrolyte is a lithium aluminum germanium phosphate-based electrolyte. The lithium aluminum germanium phosphate-based electrolyte can have a general formula of Li_{1.5}Al_{0.5}Ge_{1.5} (PO₄)₃ (LAGP).

In one embodiment of the present invention, the positive electrode is made of a material selected from the group consisting of LifePO₄ (LFP), LiCoO₂ (LCO), lithium nickel cobalt aluminum oxide (NCA), and lithium nickel cobalt manganese oxide (NCM).

In one embodiment of the present invention, the positive electrode of the lithium-ion solid-state cell has a surface layer formed from an ionic liquid.

To render the above objectives, technical features and advantages of the present invention more apparent, the present invention will be described in detail with reference to some embodiments hereinafter.

### BRIEF DESCRIPTION OF THE DRAWINGS

FIG. 1 is a schematic diagram of the structure of the lithium-ion solid-state cell of the present invention.

FIG. 2 is a curve graph showing the ionic conductivity of the negative electrode interface modification material at room temperature.

FIG. 3 is a voltage-time curve graph of a symmetric cell.

FIG. 4 is a diagram showing the impedance analysis result of a symmetric cell.

FIG. 5 is a voltage-time curve graph of a symmetrical cell.

FIG. 6 is a charge-discharge curve graph of the lithium-ion solid-state cell of the present invention.

### DETAILED DESCRIPTION

Hereinafter, some embodiments of the present invention will be described in detail. However, the present invention may be embodied in various embodiments and should not be limited to the embodiments described in the specification.

In the appended drawings, similar elements are represented by similar reference numerals. For clarity, the layers and regions may not be drawn to scale.

Unless otherwise specified, the expressions “a,” “the,” or the like recited in the specification and the claims should include both the singular and the plural forms.

Unless otherwise specified, in the specification and the claims, the term “positive electrode” refers to the cathode in a cell during discharge, and the term “negative electrode” refers to the anode in a cell during discharge.

Unless otherwise specified, in the specification and the claims, the term “ionic liquid” refers to ionic compounds in a liquid state, particularly those that enhance lithium ion mobility and possess soluble lithium salt characteristics.

Unless otherwise specified, in the specification and the claims, the unit for weight average molecular weight (Mw) is “Dalton”.

The effectiveness of the present invention compared to prior art lies in the combination of a polymer, an additive and a lithium salt in a succinonitrile-based plastic crystal electrolyte, providing a negative electrode interface modification material that can address the contact problems and side reaction issues between lithium aluminum germanium phosphate-based electrolytes and lithium metal. This enables the provision of lithium-ion cells with high chemical stability, low impedance, high electrochemical stability, and excellent cycle stability. Furthermore, the resultant lithium-ion cells can possess good mechanical properties while maintaining high ionic conductivity.

### 1. Negative Electrode Interface Modification Material

The negative electrode interface modification material of the present invention comprises succinonitrile, a polymer, a lithium salt, and an additive. In one embodiment of the present invention, the negative electrode interface modification material of the present invention essentially consists of or consists of succinonitrile, the polymer, the lithium salt, and the additive.

### [Succinonitrile]

Succinonitrile can form plastic crystals at room temperature. Plastic crystals are a mesophase formed by quasi-spherical or disk-shaped molecules that exhibit long-range translational order while displaying rotational and/or orientational disorder, thereby possessing high diffusivity and plasticity, making them usable as a matrix for electrolytes. In addition, succinonitrile can efficiently promote the solution of lithium salts, thereby enhancing ionic conductivity.

In the negative electrode interface modification material of the present invention, based on the total weight of succinonitrile, the polymer, the lithium salt, and the additive, the amount of succinonitrile preferably ranges from 60 wt % to 90 wt %. For example, based on the total weight of succinonitrile, the polymer, the lithium salt, and the additive, the amount of succinonitrile can be 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt %, or 90 wt %, or within a range between any two of the values described herein. When the amount of succinonitrile falls within the specified range, the negative electrode interface modification material of the present invention can effectively enhance the mechanical properties of the lithium-ion cells while maintaining good ionic conductivity of the cells.

### [Polymer]

In the negative electrode interface modification material of the present invention, a polymer is used to improve mechanical properties, thereby enhancing the cycle stability of the cells. Examples of the polymer include, but are not limited to, PEO, PAN, PVDF, PPC, and PMMA. The aforementioned polymers can be used individually or in any combination. Considering compatibility with other components of the negative electrode interface modification material and suitability for the composition of lithium-ion cells, the polymer is preferably PEO.

In the negative electrode interface modification material of the present invention, the weight average molecular weight of the polymer can range from 20000 to 4000000. For example, the weight average molecular weight of the polymer can be 20000, 30000, 40000, 50000, 60000, 70000, 80000, 90000, 100000, 200000, 300000, 400000, 500000, 600000, 700000, 800000, 900000, 1000000, 1500000, 2000000, 2500000, 3000000, 3500000, or 4000000, or within a range between any two of the values described herein.

In the negative electrode interface modification material of the present invention, based on the total weight of succinonitrile, the polymer, the lithium salt, and the additive, the amount of the polymer preferably ranges from greater than 0 wt % to 20 wt %. For example, based on the total weight of succinonitrile, the polymer, the lithium salt, and the additive, the amount of the polymer can be 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, or 20 wt %, or within a range between any two of the values described herein. When the amount of the polymer falls within the specified range, the negative electrode interface modification material of the present invention can efficiently enhance the mechanical properties of the lithium-ion cells while maintaining good ionic conductivity of the cells.

### [Lithium Salt]

In the negative electrode interface modification material of the present invention, the lithium salt can provide a path for lithium ion transport between the negative electrode and the solid-state electrolyte, similar to the function of an electrolyte. Examples of the lithium salt include, but are not limited to, LiTFSI, LiPF₆, LiBF₄, LiClO₄, LiAsF₆, and LiCF₃SO₃. The aforementioned lithium salts can be used individually or in any combination. In the appended examples, the lithium salt is LiTFSI.

In the negative electrode interface modification material of the present invention, based on the total weight of succinonitrile, the polymer, the lithium salt, and the additive, the amount of the lithium salt preferably ranges from 5 wt % to 15 wt %. For example, based on the total weight of succinonitrile, the polymer, the lithium salt, and the additive, the amount of the lithium salt can be 5 wt %, 6 wt %, 7 wt %, 8 wt %, 9 wt %, 10 wt %, 11 wt %, 12 wt %, 13 wt %, 14 wt %, or 15 wt %, or within a range between any two of the values described herein.

### [Additive]

In the negative electrode interface modification material of the present invention, the additive refers to an electrolyte solution additive that can address the issue of lithium metal catalyzing the nitrile polymerization reaction, thereby enhancing the cycle stability of the cell. Examples of the additive include, but are not limited to, FEC, EC, and VC. The aforementioned additives can be used individually or in any combination. Considering compatibility with other components of the negative electrode interface modification material and suitability for the composition of lithium-ion cells, the additive is preferably FEC.

In the negative electrode interface modification material of the present invention, based on the total weight of succinonitrile, the polymer, the lithium salt, and the additive, the amount of the additive preferably ranges from greater than 0 wt % to 15 wt %. For example, based on the total weight of succinonitrile, the polymer, the lithium salt, and the additive, the amount of the additive can be 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, or 15 wt %, or within a range between any two of the values described herein.

### 2. Lithium-Ion Solid-State Cell

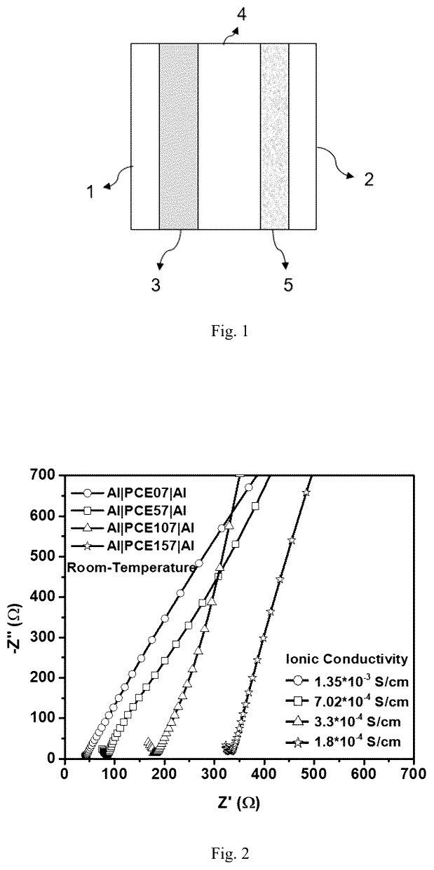

The negative electrode interface modification material can be used in lithium-ion solid-state cells. Thus, the present invention also provides a lithium-ion solid-state cell, which comprises a positive electrode, a negative electrode, a solid-state electrolyte, and the aforementioned negative electrode interface modification material, wherein the negative electrode interface modification material is disposed between the negative electrode and the solid-state electrolyte. FIG. 1 illustrates an embodiment of the lithium-ion solid-state cell of the present invention, wherein the lithium-ion solid-state cell comprises a current collector 10, a positive electrode 30, a solid-state electrolyte 40, a negative electrode interface modification material 50, and a negative electrode 20. The negative electrode interface modification material 50 is disposed between the negative electrode 20 and the solid-state electrolyte 40, the solid-state electrolyte 40 is disposed between the negative electrode interface modification material 50 and the positive electrode 30. The current collector 10 is disposed on another side of the positive electrode 30 opposite to the solid-state electrolyte 40. The current collector 10 can be made from any suitable material, such as aluminum.

The lithium-ion solid-state cell of the present invention can use known negative electrode materials. Examples of such known negative electrode materials include, but are not limited to, lithium metal, lithium-indium alloy, lithium-aluminum alloy, and silicon-lithium alloy. The aforementioned negative electrode materials can be used individually or in any combination. In the appended examples, the material of the negative electrode is lithium, such as a lithium metal sheet.

The negative electrode interface modification material of the present invention is used to modify the interface between the negative electrode and the solid-state electrolyte to address the interface issues between the solid-state electrolyte and the negative electrode (typically lithium metal), particularly the interface problems between solid-state electrolytes with a NASICON (Na super ionic conductor) structure and lithium metal. Therefore, in one embodiment of the present invention, the electrolyte is a solid-state electrolyte with a NASICON structure, such as a lithium aluminum germanium phosphate-based electrolyte and a lithium aluminum titanium phosphate-based electrolyte. Examples of the lithium aluminum germanium phosphate-based electrolyte include Li_{1.5}Al_{0.5}Ge_{1.5} (PO₄)₃ (LAGP). Examples of the lithium aluminum titanium phosphate-based electrolyte include Li_{1.4}Al_{0.4}Ti_{1.6}(PO₄)₃ (LAGP). In the appended examples, the solid-state electrolyte is LAGP.

The lithium-ion solid-state cell of the present invention can use known positive electrode materials. The positive electrode materials suitable for lithium-ion cells can be generally classified into LFP, mono lithium cathode materials, binary lithium cathode materials, and ternary lithium cathode materials. Examples of the mono lithium cathode materials include, but are not limited to, LCO, lithium nickel oxide, and lithium manganese oxide. Examples of the binary lithium cathode materials include, but are not limited to, lithium nickel cobalt oxide, LNMO (lithium nickel manganese oxide), and lithium manganese cobalt oxide. Examples of the ternary lithium cathode materials include, but are not limited to, NCA and NCM. In one embodiment of the present invention, the positive electrode is made of a material selected from the group consisting of LFP, LCO, NCA, and NCM. Examples of NCA include, but are not limited to, LiNi_{0.8}Co_{0.15}Al_{0.05}O₂, LiNi_{0.8}Co_{0.18}Al_{0.02}O₂, and LiNi_{0.9}Co_{0.05}Al_{0.05}O₂. Examples of NCM include, but are not limited to, LiNi_{0.33}Co_{0.33}Mn_{0.33}O₂ (NCM111), LiNi_{0.5}Co_{0.2}Mn_{0.3}O₂ (NCM523), LiNi_{0.6}Co_{0.2}Mn_{0.2}O₂ (NCM622) and LiNi_{0.8}Co_{0.1}Mn_{0.1}O₂ (NCM811). In the appended examples, the material of the positive electrode is LFP.

Furthermore, in the lithium-ion solid-state cell of the present invention, the positive electrode can be optionally subjected to an appropriate surface treatment or coating with other materials to further improve the interfacial stability between the positive electrode and the solid-state electrolyte, thereby reducing interfacial impedance. In the preferred embodiments of the present invention, the surface of the positive electrode has a layer formed by an ionic liquid. The ionic liquid can enhance lithium ion mobility, thereby increasing ionic conductivity. A preferred example of the ionic liquid is 1-butyl-1-methylpyrrolidinium bis(trifluoromethanesulfonyl)imide (Pyr₁₄TFSI). Pyr₁₄TFSI not only enhances ionic conductivity but also possesses good chemical stability, electrochemical stability, hydrophobicity, non-flammability, and low vapor pressure. For example, the surface of the positive electrode can have a stable surface layer formed from Pyr₁₄TFSI. Without being restricted by theories, it is believed that Pyr₁₄+ cation can form a stable lithium-ion transfer interface and reduce interfacial impedance. In addition, the surface layer helps to mitigate harmful side reactions and can enhance the performance of the positive electrode, preventing it from losing effectiveness in a short period of time.

### 3. Examples

### 3.1. Preparation and Test of Negative Electrode Interface Modification Material

First, succinonitrile, LiTFSI and FEC were mixed uniformly at 60° C., followed by adding PEO and stirring at 60° C. for one hour to obtain a mixture for preparing various negative electrode interface modification materials. The component ratios of each negative electrode interface modification material are shown in Table 1 below, and each negative electrode interface modification material is designated as PCE57, PCE107, PCE157, and PCE07, respectively.

TABLE 1
Component ratios of negative electrode
interface modification materials

| | Succinonitrile | LiTFSI | FEC | PEO |
|---|---|---|---|---|
| PCE57 | 78 wt % | 10 wt % | 5 wt % | 7 wt % |
| PCE107 | 73 wt % | 10 wt % | 10 wt % | 7 wt % |
| PCE157 | 68 wt % | 10 wt % | 15 wt % | 7 wt % |
| PCE07 | 83 wt % | 10 wt % | 0 wt % | 7 wt % |

The ionic conductivities of PCE57, PCE107, PCE157, and PCE07 were measured at room temperature using a Modular potentiostats/galvanostats (Autolab PGSTAT302N), and the results are shown in FIG. 2. As can be seen from FIG. 2, the ionic conductivity decreases with increasing PEO content, indicating that PCE07 has the highest ionic conductivity, which is 1.35×10⁻³ S/cm. Without being restricted by theories, it is believed that the decrease in ionic conductivity with increasing PEO content is attributed to the low ionic conductivity of PEO itself.

In addition, lithium metal sheets with a diameter of 8 mm and a thickness of 0.025 mm were prepared as electrode sheets. The aforementioned PCE57, PCE107, PCE157, and PCE07 were respectively pressed into electrolyte sheets with a thickness of 0.025 cm and a diameter of 1.2 cm. Then, housings for the button cell were prepared, and the stacking process was conducted in a glove box with both water and oxygen levels below 1 ppm. First, the bottom cover of the button cell was placed, followed by the lithium metal sheet (electrode sheet), electrolyte sheet, and another lithium metal sheet (electrode sheet), with the top cover of the button cell placed on top. Afterward, the symmetric cells of PCE57, PCE107, PCE157, and PCE07 were produced by pressing under a pressure of 2 MPa using a button cell tablet press.

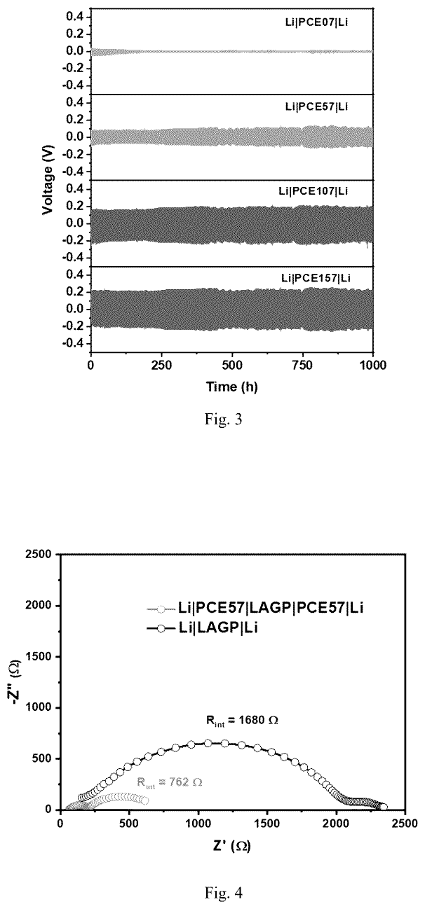

The symmetric cells were cycled under a current density of 0.05 mAh/cm² at room temperature, and the results are shown in FIG. 3. As can be seen from FIG. 3, as the PEO content increases, the overpotential also increases. Furthermore, it can be seen that PCE57, PCE107 and PCE157 all possess lithium metal stability, indicating that the negative electrode interface modification material can improve chemical stability. Considering both mechanical performance and ionic conductivity, PCE57 was selected as the negative electrode interface modification material for the lithium-ion solid-state cell described later.

### 3.2. Preparation and Test of Lithium-Ion Solid-State Cell

### [Preparation of Solid-State Electrolyte]

First, 2.63 g of lithium carbonate (Li₂CO₃), 6.16 g of germanium oxide (GeO₂), 1 (one) g of aluminum oxide (Al₂O₃) and 13.54 g of ammonium dihydrogen phosphate (NH₄H₂PO₄) were weighed and mixed uniformly to obtain a mixture. The mixture was put into a ball milling jar with a zirconium oxide lining, and 5.0 mL of isopropanol was added as a solvent. After mixing, an appropriate amount of zirconium oxide beads was added to the ball milling jar, and the mixture was ball-milled for 5 hours at a speed of 300 rpm. Afterward, the ball-milled mixture was transferred to an aluminum oxide crucible and held at 80° C. for 12 hours to evaporate the solvent, resulting in a dry powder. Then, the dry powder was ground and placed in a box furnace, where the temperature was raised to 380° C. at a heating rate of 3° C./min to perform sintering for 2 hours. Subsequently, the sintered powder was ground again using an agate mortar and pestle. The ground powder was transferred to a platinum crucible, heated to 1350° C. at a heating rate of 3° C./min to obtain a homogeneous molten liquid, which was maintained at the molten temperature for 2 hours. Then, the molten liquid was poured onto a stainless plate which has been preheated to 500° C., and pressed with another stainless plate to obtain a ceramic sheet. The ceramic sheet was annealed at 500° C. for 2 hours to release thermal stress and then cooled to room temperature. Afterward, the annealed ceramic sheet was subjected to crystallization at 950° C. for 12 hours to obtain a crystalline LAGP solid-state electrolyte sheet. The LAGP solid-state electrolyte sheet was cut, sanded and polished to obtain a LAGP solid-state electrolyte sheet with a thickness of 0.025 cm and a diameter of 1.2 cm.

### [Preparation of Electrode]

First, LFP as an active material for the positive electrode, conductive carbon KS6 as a carbon source, and PVDF as a binder were put into a mortar in a weight ratio of 75:20:5, and ground for 20 minutes. Then, 2.0 mL of N-methyl-2-pyrrolidone (NMP) as a solvent was added to the mortar, the mixture was uniformly mixed to obtain a slurry. Afterward, the slurry was coated onto an aluminum foil to form a layer with a thickness of about 150 μm, and the coated aluminum foil was dried in a vacuum oven at 100° C. for 12 hours to remove the solvent. Next, the dried film formed from the slurry was peeled off from the aluminum foil and cut into circular positive electrode sheets with a diameter of 8 mm and a thickness of 0.1 mm. Finally, 10 μL of Pyr₁₄TFSI was added onto the positive electrode sheet to moisten the positive electrode sheet, resulting in a positive electrode sheet with a surface layer formed by Pyr₁₄TFSI (hereinafter “surface layer-containing positive electrode sheet”).

In addition, a lithium metal sheet with a diameter of 8 mm and a thickness of 0.2 mm was prepared as a negative electrode sheet.

### [Preparation of Symmetric Cell]

First, PCE57 was made liquid at 60° C., and 100 μL of PCE57 was coated on both sides of the LAGP solid-state electrolyte sheet that has been pre-heated to 60° C. Then, after allowing PCE57 to slightly solidify at room temperature, the negative electrode sheets were attached to both sides of the LAGP solid-state electrolyte sheet coated with PCE 57 and fitted, and then PCE57 was allowed to fully solidify, resulting in a composite structure of negative electrode sheet|PCE57|LAGP solid-state electrolyte sheet|PCE57|negative electrode sheet. Afterward, a housing for the button cell were prepared, and the assembly was conducted in a glove box with both water and oxygen levels below 1 ppm. First, the bottom cover of the button cell was placed, followed by the composite structure of negative electrode sheet|PCE57|LAGP solid-state electrolyte sheet|PCE57|negative electrode sheet, with the top cover of button cell placed on top. Afterward, the button cell was pressed using a button cell tablet press at a pressure of 2 MPa, resulting in a symmetric cell containing PCE57.

Similarly, a symmetric cell without PCE57 was prepared, in which PCE57 was not used between the negative electrode sheet and LAGP solid-state electrolyte sheet. Thus, the structure of the symmetric cell, from bottom to top, was as follows: the bottom cover of button cell, the negative electrode sheet, LAGP solid-state electrolyte sheet, the negative electrode sheet, and the top cover of button cell.

### [Preparation of Lithium-Ion Solid-State Cell]

First, PCE57 was made liquid at 60° C., and 100 μL of PCE57 was coated on one side of the LAGP solid-state electrolyte sheet that has been pre-heated to 60° C. Then, after allowing PCE57 to slightly solidify at room temperature, the negative electrode sheet was attached to the side of the LAGP solid-state electrolyte sheet coated with PCE 57 and fitted, and then PCE57 was allowed to fully solidify, resulting in a composite structure of LAGP solid-state electrolyte sheet|PCE57|negative electrode sheet. Afterward, a housing for the button cell was prepared, and assembly was carried out a glove box with both water and oxygen levels below 1 ppm. First, the bottom cover of the button cell was placed, followed by the positive electrode sheet, the composite structure of LAGP solid-state electrolyte sheet|PCE57|negative electrode sheet (with the negative electrode sheet facing up), a spring, and finally, the top cover of the button cell. Afterward, the button cell was pressed using a button cell tablet press at a pressure of 40 MPa, resulting in a lithium-ion solid-state cell.

All the following electrochemical tests were conducted at room temperature in a glove box with both water and oxygen levels below 1 ppm. The impedance of the symmetric cell containing PCE57 and that without PCE57 were measured using a Modular potentiostats/galvanostats (Autolab PGSTAT302N) at room temperature, and the results are shown in FIG. 4. As can be seen from FIG. 4, the impedance of the symmetric cell without PCE57 reached as high as 1680Ω, while the impedance of the symmetric cell containing PCE57 was reduced to 762Ω. Without being restricted by theories, it is believed that this is due to the occurrence of side reactions when the LAGP solid-state electrolyte is in direct contact with lithium metal, leading to a higher impedance.

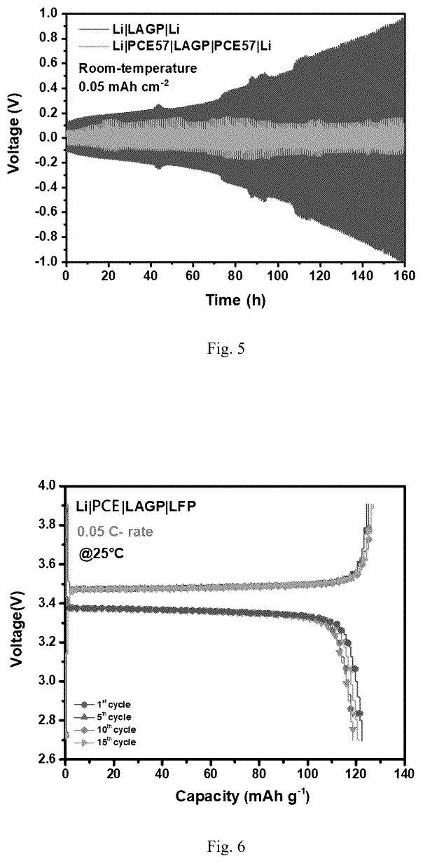

Under a current density of 0.05 mAh/cm² and at room temperature, the symmetric cell containing PCE57 and that without PCE57 were cycled, and the results are shown in FIG. 5. As can be seen from FIG. 5, the symmetric cell containing PCE57 maintains stability over 100 hours at 0.05 mAh/cm² current density. Without being restricted by theories, it is believed that this result is due to the use of the negative electrode interface modification material (i.e., PCE57), which effectively prevents or reduces side reactions caused by direct contact between lithium metal and the LAGP solid-state electrolyte.

In addition, the lithium-ion solid-state cell was cycled at a charging and discharging rate of 0.05 C and at room temperature, and the results are shown in FIG. 6. As can be seen from FIG. 6, the charge and discharge capacities during the first cycle were 123.7 mAh/g and 118.6 mAh/g, respectively, with a coulombic efficiency of 95.8% and an irreversible capacity of 4.2%. After the fifteenth cycle, the discharge capacity was 121.9 mAh/g with a coulombic efficiency of 96.8%, indicating good cycle stability. Without being restricted by theories, it is believed that the negative electrode interface modification material (i.e., PCE57) effectively avoids direct contact between lithium metal and the LAGP solid-state electrolyte, thereby reducing side reactions and enhancing cycle stability.

The above examples are used to illustrate the principle and efficacy of the present invention and show the inventive features thereof, but are not used to limit the scope of the present invention. People skilled in this field may proceed with a variety of modifications and replacements based on the disclosures and suggestions of the invention as described. Therefore, the scope of protection of the present invention is that as defined in the claims as appended.

### BRIEF DESCRIPTION OF REFERENCE NUMERALS

10: current collector
20: negative electrode
30: positive electrode
40: solid-state electrolyte
50: negative electrode interface modification material

What is claimed is:

1. A negative electrode interface modification material, which comprises succinonitrile, a polymer, a lithium salt, and an additive.

2. The negative electrode interface modification material of claim 1, wherein the polymer is selected from the group consisting of poly(ethylene oxide) (PEO), polyacrylonitrile (PAN), poly(vinylidene difluoride) (PVDF), poly(propylene carbonate) (PPC), poly(methyl methacrylate) (PMMA), and combinations thereof.

3. The negative electrode interface modification material of claim 1, wherein the lithium salt is selected from the group consisting of lithium bis(trifluoromethanesulfonyl)imide (LiTFSI), LiPF₆, LiBF₄, LiClO₄, LiAsF₆, LiCF₃SO₃, and combinations thereof.

4. The negative electrode interface modification material of claim 1, wherein the additive is selected from the group consisting of fluoroethylene carbonate (FEC), ethylene carbonate (EC), vinylene carbonate (VC), and combinations thereof.

5. The negative electrode interface modification material of claim 1, wherein based on the total weight of succinonitrile, the polymer, the lithium salt, and the additive, the amount of the polymer ranges from greater than 0 wt % to 20 wt %, and the amount of the additive ranges from greater than 0 wt % to 15 wt %.

6. The negative electrode interface modification material of claim 2, wherein based on the total weight of succinonitrile, the polymer, the lithium salt, and the additive, the amount of the polymer ranges from greater than 0 wt % to 20 wt %, and the amount of the additive ranges from greater than 0 wt % to 15 wt %.

7. The negative electrode interface modification material of claim 3, wherein based on the total weight of succinonitrile, the polymer, the lithium salt, and the additive, the amount of the polymer ranges from greater than 0 wt % to 20 wt %, and the amount of the additive ranges from greater than 0 wt % to 15 wt %.

8. The negative electrode interface modification material of claim 4, wherein based on the total weight of succinonitrile, the polymer, the lithium salt, and the additive, the amount of the polymer ranges from greater than 0 wt % to 20 wt %, and the amount of the additive ranges from greater than 0 wt % to 15 wt %.

9. A lithium-ion solid-state cell, which comprises a positive electrode, a negative electrode, a solid-state electrolyte, and the negative electrode interface modification material of claim 1, wherein the negative electrode interface modification material is disposed between the negative electrode and the solid-state electrolyte.

10. The lithium-ion solid-state cell of claim 9, wherein the negative electrode is made of a material selected from the group consisting of lithium metal, a lithium-indium alloy, a lithium-aluminum alloy, a silicon-lithium alloy, and combinations thereof.

11. The lithium-ion solid-state cell of claim 9, wherein the solid-state electrolyte is a lithium aluminum germanium phosphate-based electrolyte.

12. The lithium-ion solid-state cell of claim 10, wherein the solid-state electrolyte is a lithium aluminum germanium phosphate-based electrolyte.

13. The lithium-ion solid-state cell of claim 11, wherein the lithium aluminum germanium phosphate-based electrolyte has a general formula of Li_{1.5}Al_{0.5}Ge_{1.5} (PO₄)₃ (LAGP).

14. The lithium-ion solid-state cell of claim 12, wherein the lithium aluminum germanium phosphate-based electrolyte has a general formula of Li_{1.5}Al_{0.5}Ge_{1.5} (PO₄)₃ (LAGP).

15. The lithium-ion solid-state cell of claim 11, wherein the positive electrode is made of a material selected from the group consisting of LifePO₄ (LFP), LiCoO₂ (LCO), lithium nickel cobalt aluminum oxide (NCA), and lithium nickel cobalt manganese oxide (NCM).

16. The lithium-ion solid-state cell of claim 12, wherein the positive electrode is made of a material selected from the group consisting of LiFePO₄ (LFP), LiCoO₂ (LCO), lithium nickel cobalt aluminum oxide (NCA), and lithium nickel cobalt manganese oxide (NCM).
